(19) United States
(12) Patent Application Publication
(10) Pub. No.: US 2014/0377034 A1
(43) Pub. Date: Dec. 25, 2014

(54) SECURITY SEAL FASTENER SYSTEM

(71) Applicant: Raytheon Company, Waltham, MA (US)

(72) Inventors: Rodrick R. Cottrell, Fort Wayne, IN (US); Paul D. Richwine, Fort Wayne, IN (US); Gregory A. Cantrell, Fort Wayne, IN (US)

(21) Appl. No.: 13/921,425

(22) Filed: Jun. 19, 2013

(51) Int. Cl. F16B 29/00; F16B 39/08

(52) U.S. Cl. CPC F16B 29/00; F16B 39/08
USPC 411/315; 411/375; 29/525.02

(57) ABSTRACT

A security seal fastener system includes a fastener, and an enclosure around a head of the fastener that provides visual evidence of access to the head after installation of the fastener. The enclosure may include a washer that is around a shaft of the fastener, and a cap that closes off an access opening in the washer. The cap has a spring that engages a groove in an inner surface of the washer, to lock the cap in place. A flange of the cap and a ridge of the washer prevent access to the spring. The washer has an anti-rotation feature to prevent rotation of the fastening system while the enclosure is intact. The cap has a knockout that can be perforated or removed to allow access to the head of the fastener, for removal of the fastener. The cap may have an identifier, such as a serial number.

### BACKGROUND OF THE INVENTION

1. Technical Field of the Invention

The invention is in the field of security fasteners and systems that resist tampering and/or provide evidence of tampering.

2. Description of the Related Art

Security seals are used in a number of situations in which it is important that access be prevented, discouraged, or controlled. Examples include access covers and other access points for sensitive equipment such as voting machines, cryptographic equipment, and equipment that can be reverse engineered. Many available commercial off the shelf (COTS) security seal design types (labels, wire loop seals, plastic loop seals, lock seals, and cup seals) have been publicly documented to be compromised in that they can be removed and reinstalled in some cases in seconds while still not showing physical evidence of tamper. Many COTS security seal design types also do not maintain their seal performance under external environment conditions for immersion, and hot and cold temperature extreme ranges.

### SUMMARY OF THE INVENTION

According to an aspect of the invention, an anti-tampering fastener system includes: a fastener having a head and a shaft; and an enclosure around the head that provides detectable evidence when the head has been accessed, the enclosure including: a washer; and a cap. The washer and the cap are engaged with a resilient member of one of the washer and the cap being locked in a groove in the other of the washer and the cap.

According to another aspect of the invention, a method of protecting a fastener from tampering, the method including: threading a shaft of the fastener into an object, wherein the threaded includes securing a bottom wall of the washer between the object and a head of the fastener; and closing off an access opening in the washer, through which the head may be accessed, by inserting a cap into the opening. The closing off includes locking the cap in place through engagement of a spring with both a cap groove of the cap and a washer groove on an inner surface of the washer.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various features of the invention.

FIG. 1 is an exploded view of a security fastener seal system in accordance with an embodiment of the invention.

FIG. 2 is an exploded view of an enclosure of the security fastener seal system of FIG. 1.

FIG. 3 is an oblique view of the washer of the security fastener seal system of FIG. 1.

FIG. 4 is a side cross-sectional view of the washer of FIG. 3.

FIG. 5 is a side cross-sectional view of a cap of the security fastener seal system of FIG. 1.

### DETAILED DESCRIPTION

A security seal fastener system includes a fastener, and an enclosure around a head of the fastener that provides visual evidence of access to the head after installation of the fastener. The enclosure may include a washer that is around a shaft of the fastener, and a cap that closes off an access opening in the washer. The cap has a spring that engages a groove in an inner surface of the washer, to lock the cap in place in the washer. A flange of the cap and a ridge of the washer prevent access to the spring within the groove. The washer has an anti-rotation feature, such as a pin that engages a corresponding hole in an object that the fastener system is installed on, to prevent rotation of the fastening system as a unit while the enclosure is still intact. The cap has a knockout that can be perforated or removed to allow access to the head of the fastener, for removal of the fastener. The cap may have an identifier, such as a serial number, that prevents substitution of an intact cap after the cap has been breached or removed. The fastener system is easily and quickly installable without any specialized tools. The fastener system is able to function over a large range of temperatures, is insensitive to immersion in liquids, and can survive exposure to chemicals such as solvents.

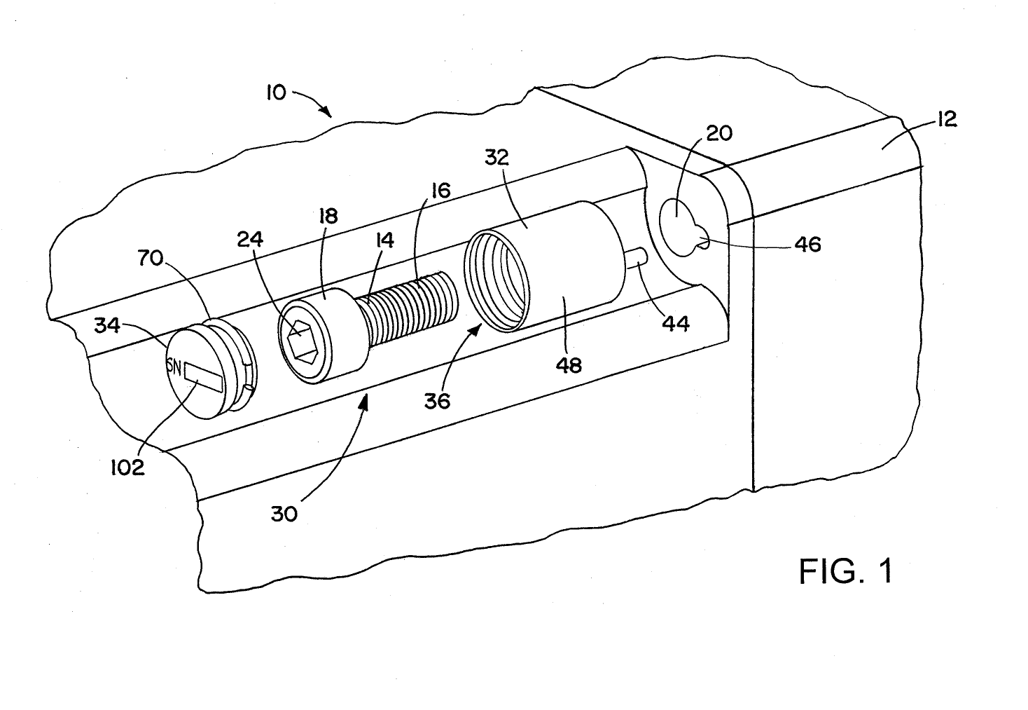

FIG. 1 shows a security seal fastener system 10 which is installed on an object 12. The object 12 may be any of a wide variety of objects for which it is desirable to control access, such as by discouraging access or at least providing evidence of access. The object 12 may be a piece of sensitive equipment, such as a voting machine, cryptographic module, or equipment capable of being reverse engineered, with the fastener system 10 installed at an access panel or other location where access to the object 12 is controlled. The object 12 may also be part of a container the contents of which are to be secured, one example being a truck trailer, and another example being a housing for a device under a warranty, with the housing not be opened by an unauthorized user.

The fastener system 10 includes a fastener 14 that has a shaft 16 and a head 18. The fastener 10 engages a hole 20 in the object 12. In the illustrated embodiment the fastener 14 is a threaded fastener, a bolt that has a threaded shaft 16 that is inserted into a hole 20, which may be threaded. Alternatively the shaft may be configured to be inserted and then turned to engage the fastener to the object, with for example the shaft being keyed to fit into the hole at a particular orientation, while resisting withdrawal when in a different orientation.

The head 18 may have a suitable shape for receiving a tool for turning the fastener 14, to engage the fastener 14 with the hole 20. In the illustrated embodiment the head 18 has a hex-shape depression 24 for receiving an Allen or hex wrench. Alternatively the head 18 have any of a variety of tools, examples being a single slot (for a flat-blade screwdriver), crossed slots (for a Phillips-head screwdriver), a hexagon shape (for a socket or other wrench), or a star shape (for a star-shape or TORX wrench).

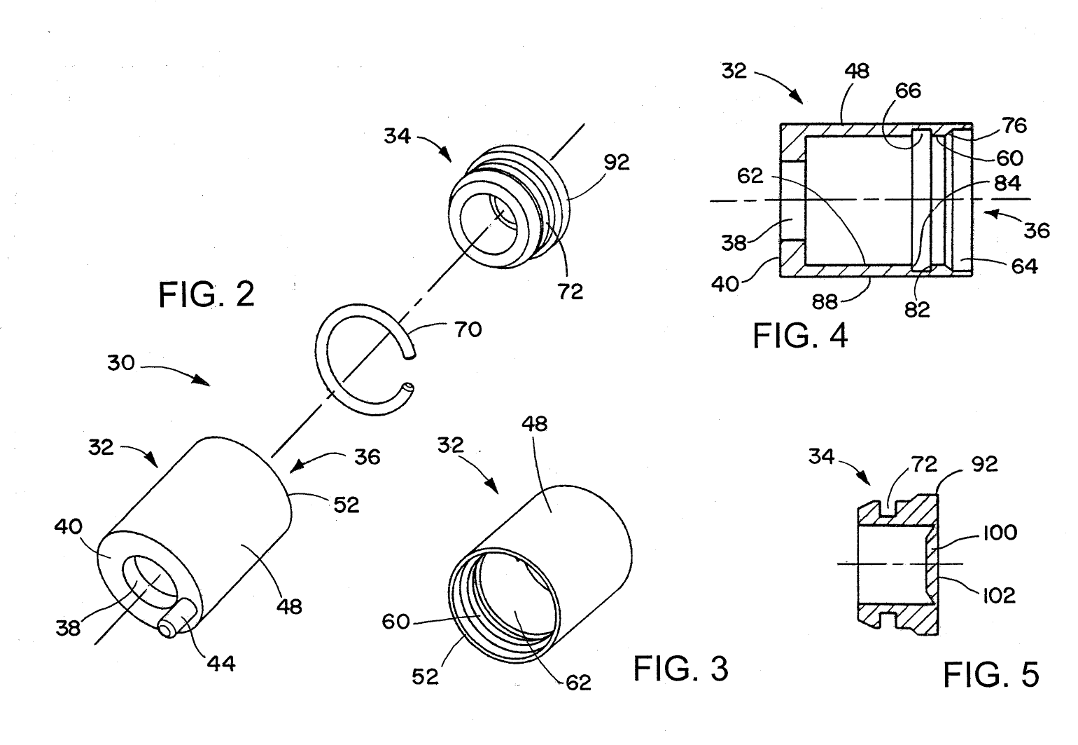

When the fastener 14 is installed on the object 12, the head 18 is enclosed by an enclosure 30, to prevent undetectable access to the head 18. With reference in addition to FIG. 2, the enclosure 30 includes a washer 32, and a cap 34 that closes off an opening 36 in the washer 32. The washer 32 has a cylindrical shape with a hole 38 in a bottom wall 40 of the washer 32. The hole 38 is sized to allow the shaft 16 of the fastener 14, but not the head 18, to pass through. When the fastener system 10 is installed on the object 12, the bottom wall 40 is clamped between the head 18 and the object 12.

A pin 44 extends outward from the bottom wall 40, in the direction toward the object 12 when the fastener system 10 is installed. The pin 44 fits into a corresponding hole 46 in the object, with the pin 44 acting as an anti-rotation device or feature to preventing rotation of the fastener system 10 as a unit after installation. This prevents an unauthorized person from defeating the security of the fastener system 10 by filling up the space within the enclosure 30 with some material such of glue or epoxy that will fixedly couple the washer 32 to the fastener 14, and then using a gripping tool such as pliers to turn the washer 32, thus turning the fastener 14 as well. The pin anti-rotation device 44 prevents turning of the washer 32 while the fastener 14 is still installed in the object 12. The washer 32 and the pin 44 may be configured such that attempts to grip and rotate the washer 32 will cause visible deformation of the washer 32 (deforming its cylindrical body 48) long before any shearing or other failure of the pin 44 occurs. Having the pin 44 adjacent to the perimeter of the cylindrical body 48 facilitates making visible any deformation of the washer 32 in the vicinity of the pin 44.

The washer's cylindrical body 48 that extends well beyond sides of the head 18, with the body 48 culminating in the opening 36. The opening 36 allows for insertion of a tool for tightening (or rotating) the fastener 14, during installation of the fastener system 10.

After installation of the fastener 14, the opening 36 is closed off by installation of the cap 34. The cap 34 is inserted into the opening by manually pushing it in, perhaps augmented by tapping with a rubber mallet or other such tool. When fully installed the cap 34 may be flush with a top edge 52 of the washer 32. Having the cap 34 flush with the washer 32 makes it harder for someone wanting access to the fastener head 18 to grip the cap 34, such as with pliers, in an attempt to pull the cap 34 out of the opening 36.

FIGS. 3-5 provide more details regarding the coupling between the cap 34 and the washer 32. The washer 32 has a ridge 60 on an inner surface 62 of the cylindrical body 48. The ridge 60 is bounded by and defined by an expanded diameter outer portion 64, between the ridge 60 and the opening 36, and a washer groove 66 that is further than the ridge 60 from the opening 36. The cap 34 has a spring 70, a resilient C-shape member, that is located in a cap groove 72 in the cap 34. The spring 70 has an unconstrained shape that leaves some clearance between it and the bottom of the cap groove 72. The height of the ridge 60 is such that it contacts the spring 70 as the cap 34 is inserted into the opening 36, driving the spring 70 inward into the cap groove 72 sufficient to allow the spring 70 to pass the ridge 60. The ridge 60 has a sloped surface or chamfer 76 on its side surface that faces the opening 36, to facilitate the resilient deformation of the spring 70 into the cap groove 72. Once the spring 70 clears the ridge 60, moving further into the cylindrical body 48, the spring 70 reaches the washer groove 66, at which point it resiliently springs radially outward into the washer groove 66. The washer groove 66 has a pair of steep side walls 82 and 84, for example being substantially perpendicular to an outer surface 88 of the cylindrical body 48. The side walls 82 and 84 help lock the spring 70 in place in the washer groove 66. The engagement of the spring 70 with both of the grooves 66 and 72 locks the cap 34 in place within the washer 32.

The spring 70 has a circular cross section in the illustrated embodiment. Alternatively, the spring 70 may have a rectangular gross section, perhaps with a chamfer to aid its inward movement upon encountering the ridge 60.

The spring 70 extends most of the way around the perimeter of the cap 34. For example, the spring 70 may extend at least 75% of the way around the perimeter, and may extend at least 90% of the way around the perimeter. The spring 70, because it extends around most of the perimeter of the cap 34, is more difficult to defeat than a series of resilient fingers or other devices placed around the circumference of a seal cap. A series of separate devices can be disengaged sequentially and individually, which is not the case for the spring 70, which must be disengaged from one of the grooves 66 and 72 all at once.

The cap 34 has a flange 92 that extends radially outward along the perimeter of the cap 34 at the end of the cap 34 where the cap 34 is flush with the washer top edge 52. The flange 92 is located in the outer portion 64 when the cap 34 is fully installed on the washer 32. The flange 92 overlaps the ridge 60, that is, the gap between the flange 92 and the cylindrical body 48 is less than the height of the ridge 60 (the inward protrusion of the ridge 60 beyond the outer portion 64). The overlapping of the ridge 60 by the flange 92 prevents a straight route of access to the spring 70 from outside the enclosure 30. Instead some sort of bending of an inserted object would be required to reach the spring 70. By making access to the spring 70 difficult, if not as a practical matter impossible, dislodgement of the spring 70 from the washer groove 66 cannot be accomplished without destruction of the cap 34. This prevents removal and reinsertion of the cap 34 as a possible way of defeating the security of the fastener system 10. However, as an alternative the flange 92 need not overlap the ridge 60.

As shown in FIG. 5, the cap 34 has a knockout 100 and an identifier 102. The knockout 100 is a weakened central part of the cap 34 that can be punched out or opened up to allow access to interior of the enclosure 30. Specifically, the knockout 100 may be opened up to allow insertion of a suitable tool to engage the head 18, for unscrewing the fastener 14. Access through the knockout 100 leaves visual evidence of the access, so that while unauthorized access may be effected through the knockout 100, that access will be detectable.

The identifier 102 provides a way of identifying the cap 34, to prevent concealing access (removal of the fastener 14) by replacement of the cap 34 (or replacement of the entire fastener system 10). The cap 34 may be a unique numerical or alphanumeric serial number, with different caps having different identifiers. The identifier 102 may be etched or stamped on a face of the cap 34. Different ranges of identifiers (e.g., serial numbers) may be reserved for different users or different fields of use. A wide range of alternative visual and non-visual identifiers may be used, examples of alternatives being barcodes and radio frequency identification devices. Combinations of different types of identifiers may also be used. The use of the identifier 102 may also aid in tracking of objects and/or the fastener systems.

The parts of fastener system 10 may be made of any of a variety of suitable materials. The fastener 14 may be a standard fastener, for example being made out of steel. The washer 32 and the cap 34 may be made out of any of a variety of suitable (preferably rigid) materials, for example being made out of a suitable metal (e.g., zinc or steel, such as stainless steel) or a suitable rigid plastic. Suitable materials may be selected based on the environment that the fastener system 10 will be exposed to, for example taking into account such factors are temperature (including range of temperature), possible exposure to liquids (include possible immersion), and exposure to chemicals, such as exposure to solvents. It may be advantageous to make the washer 32 and the cap 34 out of the same material, for instance to have the two parts expand or contract similarly during temperature changes.

The cap 34 may have a coating to make attempts at tampering more visually evident. For example a metal cap 34 may be anodized. A black oxide coating may be formed on stainless steel, for instance. As an alternative, metal and non-metal parts may be painted as an aid to detecting tampering. If desired, the washer 32 may also be coated, for similar purposes.

The washer pin 44 that engages the hole 46 is only one example of many possible anti-rotation feature to keep the fastener system 10 from being rotated as a unit. The anti-rotation feature may be some sort of protrusion on the fastener system 10 that engages the object 12 to prevent rotation. Alternatively the anti-rotation feature may be a protrusion on the object 12 that engages a recess or other part of the fastener system 10 to prevent rotation. As a further alternative, the washer 32 may have a non-circular body shape or body portion that engages a corresponding recess in the object 12 in such a way that rotation of the installed fastener system 10 is prevented. The anti-rotation feature may include a keyed pattern on one of the washer 32 or the object 12, which engages a corresponding pattern on the other of the washer 32 or the object 12, the pin 44 and the hole 46 being one example of such a feature. Some anti-rotation features may be better suited than others for situations in which the fastener system 10 is used to retrofit an already-produced object.

The fastener system 10 offers many advantages, some of which are described above. It may be easily and quickly installed, without a need for special tools or for setting of curable seal materials. Once the system 10 is installed the fastener head 18 is inaccessible without leaving of detectable evidence of access or other tampering. Many types of attempted tampering will leave visual evidence, even when the attempted access fails. Access to the fastener head 18 can still be had easily for removal of the fastener system 10, through the knockout 100, but this access is in a way that it cannot readily be hidden, especially in view of the identifier 102 on the cap 34.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An anti-tampering fastener system comprising:
a fastener having a head and a shaft; and
an enclosure around the head that provides detectable evidence when the head has been accessed, the enclosure including:
a washer; and
a cap;
wherein the washer and the cap are engaged with a resilient member of one of the washer and the cap being locked in a groove in the other of the washer and the cap.

2. The fastener system of claim 1,
wherein the groove is a washer groove in the washer; and
wherein the resilient member is in a cap groove in the cap.

3. The fastener system of claim 2, wherein the resilient member is a curved spring that extends most of the way around a perimeter of the cap.

4. The fastener system of claim 3, wherein the spring extends at least 90% of the way around the perimeter of the cap.

5. The fastener system of claim 2,
wherein washer includes a ridge on an inner surface of the washer, between the washer groove and an opening in the washer into which the cap is inserted; and
wherein the resilient member resiliently compresses to pass the ridge, and expands to lock into the washer groove.

6. The fastener system of claim 5, wherein the ridge has a chamfered surface facing the opening.

7. The fastener system of claim 5, wherein the cap has a flange that overlies the ridge when the cap is installed, with a gap between the flange and the washer being less than a height of the ridge.

8. The fastener system of claim 1, wherein the washer has a cylindrical shape.

9. The fastener system of claim 1, wherein the washer has a bottom wall, with a hole therein for allowing the shaft, but not the head, to enter the hole.

10. The fastener system of claim 1, wherein the washer has anti-rotation feature that engages an object that the fastener is installed on, to prevent rotation of the washer while the fastener is installed.

11. The fastener system of claim 10, wherein the anti-rotation feature is a keyed coupling between the washer and the object.

12. The fastener system of claim 10, wherein the anti-rotation feature includes a pin of the washer that is insertable into a corresponding hole in the object to prevent rotation.

13. The fastener system of claim 1, wherein the cap and the washer are made of the same material.

14. The fastener system of claim 1, wherein the cap has a coating for providing visual evidence of attempted tampering.

15. The fastener system of claim 1, wherein the cap has a weakened knockout that can be perforated for access to the head of the fastener.

16. The fastener system of claim 1, wherein the cap includes an identifier.

17. The fastener system of claim 16, wherein the identifier is a serial number on the cap.

18. The fastener system of claim 1, wherein the fastener is a threaded fastener.

19. A method of protecting a fastener from tampering, the method comprising:
threading a shaft of the fastener into an object, wherein the threaded includes securing a bottom wall of the washer between the object and a head of the fastener; and
closing off an access opening in the washer, through which the head may be accessed, by inserting a cap into the opening;
wherein the closing off includes locking the cap in place through engagement of a spring with both a cap groove of the cap and a washer groove on an inner surface of the washer.

20. The method of claim 19, wherein the closing off includes inserting the cap into the opening until the cap is substantially flush with the washer.
